(19) United States
(12) Patent Application Publication
(10) Pub. No.: US 2024/0056462 A1
(43) Pub. Date: Feb. 15, 2024

(54) COMPUTERIZED SYSTEM FOR TEMPORAL, VOLUME, AND VELOCITY ANALYSIS OF AN ELECTRONIC COMMUNICATION SYSTEM

(71) Applicant: Virtual Connect Technologies, Inc., Greenville, SC (US)

(72) Inventors: Benjamin Hathaway, Greenville, SC (US); Theodore Wecker, Durango, CO (US); Andrew Barringer, Duncan, SC (US)

(73) Assignee: Virtual Connect Technologies, Inc., Greenville, SC (US)

(21) Appl. No.: 18/362,891

(22) Filed: Jul. 31, 2023

Related U.S. Application Data
(60) Provisional application No. 63/398,127, filed on Aug. 15, 2022.

(51) Int. Cl. H04L 9/40; H04L 51/02; H04L 51/224

(52) U.S. Cl. CPC H04L 63/1425; H04L 63/1416; H04L 51/02; H04L 51/224

(57) ABSTRACT

A computerized system for temporal, volume, and velocity analysis of electronic communication systems comprising: a set of computer readable instructions in communications with a message system adapted for determining a user pattern, a user environment, user location, or user schedule, determining is an electronic message is sent contrary to the user information and taking action on the electronic message taken from the group consisting of deletion, quarantine, notification, warning, re-routing, and any combination.

### RELATED APPLICATION

This application claims priority from U.S. Provisional Patent Application 63/398,142 filed Aug. 15, 2022, U.S. Provisional Patent Application 63/398,137 filed Aug. 15, 2022, U.S. Provisional Patent Application 63/398,132 filed Aug. 15, 2022, and U.S. Provisional Patent Application 63/398,127 filed Aug. 15, 2022 each incorporated herein by reference.

### BACKGROUND OF THE INVENTION

### 1) Field of the Invention

This system is directed to a computerized system for extracting, analyzing, aggregating, and storing senders' behavior including temporal patterns of messages, volume, frequency, velocity, and acceleration or declaration of messages.

### 2) Description of the Related Art

The use of electronic messages, especially email, is prevalent in today's society. It is estimated that billions of emails are sent per day. Email is being used for several purposes including personal communications, business communications, marketing, advertising, multi-party communications, collaboration, transmitting attachments, documents, or any other informational interactions, as well as many other uses. With increased use there also comes an increased risk.

One such risk is that an electronic message account is subject to unauthorized access. An unauthorized electronic message account can have any number of underlying causes and techniques including social engineering tactics, password leaks, account hijacking, impersonating, and the like. The reasons that a hacker would want to have access to an electronic message account can vary, but includes the ability to access personal information, health information, financial information, and the associated accounts. It is common for a user to use an email address as the primary identifier when logging into other systems. With access to an email account, a hacker can reset the user's password for a given website and the reset link can be sent to the email inbox so that the hackers can then reset the password allowing the hacker access to the website or account. Further, email is a common storage place for sensitive information including financial statements, agreements, personal photos, and other sensitive and private information including account and identifying information.

There is also a specific email attack that is more common with business emails. It targets business decision makers and seeks to have unauthorized financial transactions initiated by a hacker impersonating the business decision makers. A form of this attack is also known as conversation hijacking where the hacker attempts to insert themselves into existing business conversations to take money or personal information without permission. Another risk is when the account is subject to a takeover and the hacker uses the account for further illegal activity, such as the source of spam, phishing, scamming, spear-phishing, domain impersonation, brand impersonation, and the like. In one study, it was concluded that about 29 percent of Microsoft Office 365 accounts have been compromised. Using these compromised accounts, hackers were able to send in excess of 1.5 million malicious and spam emails.

Techniques used to take over an account include using login credentials from data breach databases, published in criminal forums, use of stolen passwords from personal email accounts to gain access to business email, social engineering tactics, and the like.

While these risks are growing, it is understood that the electronic message systems provide the ability to have very fast delivery of information from a remote geographic location, can be sent and received 24 hours a day, 365 days a year, can be accessed with any computer system using a cloud-based system so that personal devices are not required, are inexpensive and can be used on a one-to-one or one-on-one basis to procure its distribution. Therefore, it is unlikely that electronic message systems, including email, will be retired any time soon. Further, it is commonly stated that it is not a matter of whether a breach will occur, but when. Having tools and processes in place that can identify and prevent the user of a breached account would be of great importance.

There have been attempts to automatically filter or identify undesirable electronic messages that can be received from hackers. For example, U.S. Pat. No. 9,501,746 which discloses a system related to detecting bad actors that impersonate other people's identity in order to increase the likelihood of recipients opening these bad actors' messages and attachments. This patent states that this undesirable activity is generally referred to as “phishing” and specifically “spear phishing” when the recipient is targeted by the fake sender who is referred to as a “phisher.” This patent also states that these phishers send these “fake emails” seeking to increase their likelihood of successfully gaining unauthorized access to confidential data, trade secrets, state secrets, military information, and other information. The motivation of these phishers is typically for financial gain through fraud, identity theft, and/or data theft. The phishers may also be those who wish to disrupt normal operations. Phishing attempts have been associated with private entities, being state-sponsored, as well as being from foreign governments themselves. While detecting an unauthorized access attempt has some benefit, it would be desirable to have a system that can reduce or eliminate the risks when a breach occurs.

Another attempt to detect and/or handle targeted attacks is shown in U.S. Pat. Nos. 9,686,308 and 10,181,957 which discloses a system for detecting and/or handling target attacks in an enterprise's email channel. This patent discloses receiving aspects of an incoming electronic message addressed to a first email account holder, selecting a recipient interaction profile, and/or a sender profile from a plurality of predetermined profiles stored in a memory, determining a message trust rating associated with the incoming email message based upon the incoming email message, the selected recipient interaction profile, and/or the sender profile; and generating an alert identifying the incoming email message as including a security risk based upon the determined message's trust rating. However, these techniques are limited to preventing an attack, not reacting to one.

Typically, attempts to reduce email risks are directed to detecting and preventing attacks, not reacting to a successful attack. For example, U.S. Pat. No. 7,634,810 discloses a phishing detection module that detects a phishing attack in the communication by determining if the domain of the message source is similar to a known phishing domain, or by detecting suspicious network properties of the domain. This attempt requires that information about the message domain is known allowing bad actors to simply change domains to overcome this system.

Another attempt to detect, prevent, and provide notification of phishing attempts is shown in U.S. Pat. No. 10,404,745 which discloses the use of natural language techniques and information present in an email (namely the header, links, and text in the body) to detect phishing. This system is limited to an analysis of the email itself and occurs once the phishing attempt or attack has been initiated. While detection and prevention can be advantageous, a system that handles the success attack is needed. Unfortunately, the historical activities such as subscribing to a spam filter are no longer sufficient and a more sophisticated approach is needed. One strategy is to develop a layered approach which should include preventive measures at the perimeter and not just once the email arrives in the inbox or email system.

When an electronic message account is breached, there can be some indications that the breach has occurred. Some signs that can be used to determine that a breach has occurred include changing passwords, emails in an inbox that are not recognized, unexpected emails are received, IP addresses are present in a log, individuals in a contact list begin to receive spam messages from the account holder and message volumes and patterns change. However, these indicators require the user to note that change and potentially react.

While the behavior of the user has been the subject of some systems, such as in U.S. Pat. No. 11,019,000, these systems do not consider the identification or reaction to unauthorized access. This reference is limited to aid the account holder for managing inbound email by detecting, and configurably responding to, dynamically variable patterns of activity and behavior of the recipient. Unfortunately, this attempt to solve email management issues falls short when applied to unauthorized access and attacks. Further, the recipient must open, review, and take some action on the email for the system of this reference to properly operate.

U.S. Pat. No. 9,344,394 is also an attempt to improve management of email volume. This reference contends that it performs thread-based message prioritization by using metadata that can be extracted from a received electronic message. Again, this system operates on an email message that has already been received by the electronic message system. It seeks to prioritize emails based upon the thread information. U.S. Pat. No. 7,865,458 states that it is a method and system for enforcing rule selection on user email inboxes that includes an inbox monitor and administrative rules at an email server. Again, these systems require that the email arrives at the recipient's inbox while activity of the user with the user's inbox is not directed to the analysis and reaction to a breach.

There has been some attempt to detect breaches such as shown in United States Patent Application Publication 20190260780 which states that it is a cyber threat defense system protecting email networks with machine learning models. This system, however, is limited to the information that is contained in the email system without the ability to determine whether such data is consistent with disparate or remote information or system.

Therefore, it is an object of the system to provide for a computerized system that can determine a breach and react to the breach.

It is another object of the system to allow for the unauthorized account to

be deactivated or otherwise modified in response to a breach.

It is another object of the system to detect an unauthorized account by comparison to disparate and remote data associated with the account.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of aspects of the system.

FIGS. 2A and 2B are images of aspects of the system.

FIGS. 3A and 3B are images of aspects of the system.

FIG. 4 is an image of aspects of the system.

FIG. 5 is an image of aspects of the system.

FIG. 6 is an image of aspects of the system.

FIG. 7 is a schematic of aspects of the system.

FIG. 8 is a schematic of aspects of the system.

### DETAILED DESCRIPTION OF THE INVENTION

With reference to the drawings, the invention will now be described in more detail.

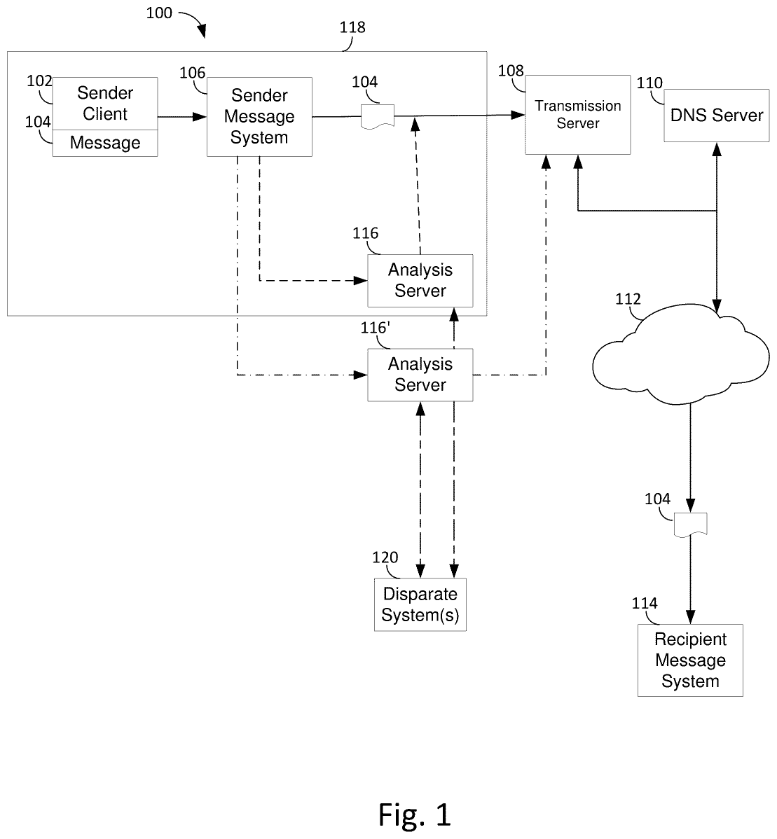

Referring to FIG. 1, and using an email system as an example, a message management system is shown generally as 100. Sender client 102 can be used to create a message 104. The sender client can be local, remote, online, mobile accessed through SaaS (e.g., cloud based) or other device in communications with the sender message system 106. The sender message system 106 can then transmit the message 104 to a transmission server 108, such as a SMTP server, and then directed to a recipient's destination using routing information such as obtained by a domain name system (DNS) 110. The DNS can provide routing information concerning where to send the electronic message through a global communications network 112. The electronic message 104 can be transmitted to recipient message system 114 which can be through a network such as a global communications network 112.

Analysis server 116 can be adapted to receive information about messages originating from the sender's message system through several communications paths. For example, the analysis server can be within the recipient's domain 118 so that the sender message system and the analysis system 116 can be in communications and in the same domain. In the embodiment, the analysis system can receive the message, analyze the message, and send the message on to a transmission server 108. In one embodiment, the analysis system 116′ can receive the message, analyze the message, and send the message on to a transmission server 108 so that the analysis server is outside the recipient's domain.

The analysis server can be in communications with one or more disparate information sources 120 including the sender's schedule, office hours and patterns, time zone, geographic locations, vacation schedule, historical behavior including sending and receiving frequency and velocity and the like. The disparate information source can include information from the sender's message system itself such as login patterns, actions within the sender's account (e.g., message read, delete, reply, marking, forwarding, quarantine, and the like).

In one embodiment, prior to the message arising at the recipient message system 114, the message can be intercepted by the analysis server 116. The analysis server can be determined using the MX record information in one embodiment so that the electronic message routes through the analysis server instead of directly to a recipient message system. This allows the electronic message to be analyzed and potential warning or actions taken prior to the message being sent to the recipient's message system and even prior to the message being sent outside the sender's domain.

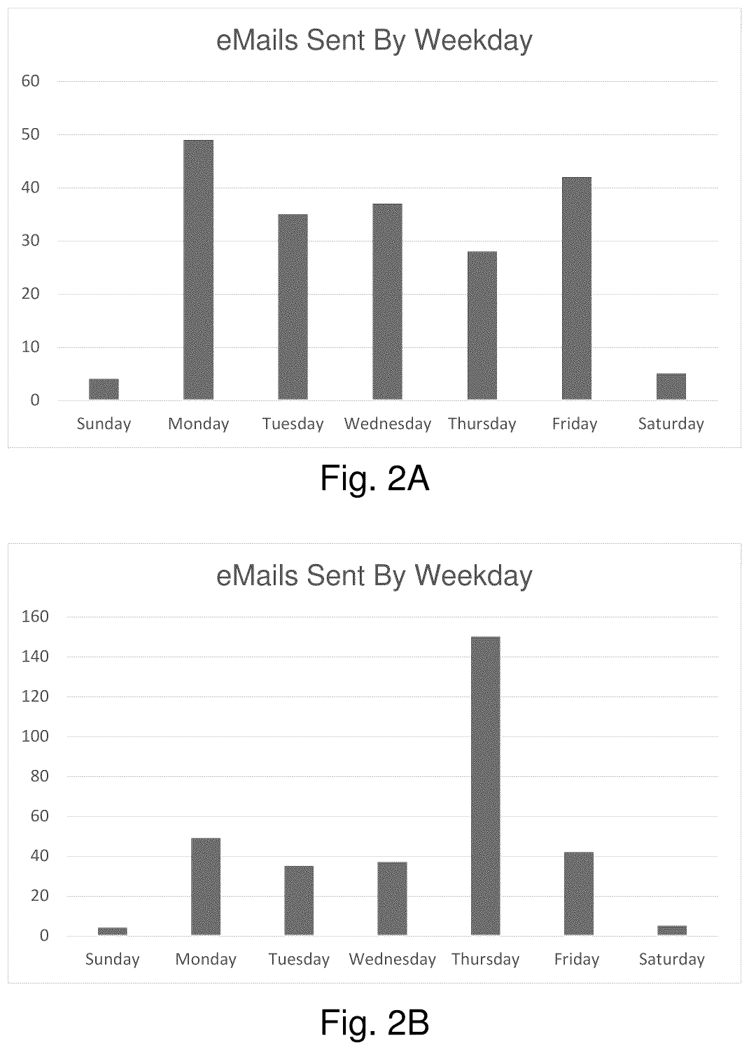

The analysis server can determine or receive from the sender's message system information such as temporal patterns, volume, frequency, velocity, and acceleration or declaration of sent messages. In one embodiment, the message activity can be tracked according to several temporal characteristics. For example, the number of emails that are sent in a day, week, or month. The sending of an email can be tracked according to the day of the week, such as a normal work week (e.g., Monday through Friday), or some other work schedule. The system can display the email activity in a graph such as the one shown in FIG. 2A. The analysis server can determine the number of emails sent for a week, a month, quarter, year, or other period of time. The number of emails sent can be a total, average, mean or other calculation over a period of time. The analysis server can also determine deviations from a baseline value. For example, if the sender typically sends between 40 emails each Monday, the analysis server can determine that a day with 55 emails is potentially abnormal and outside an expected range. In one embodiment, the analysis server can calculate a deviation from an expected value using the following equation:

$$σ = \sqrt{\frac{\sum {( {x}_{i} - μ )}^{2}}{N}}$$

where σ is the data standard deviation, N is the size of the sample set to be analyzed, xᵢ is each value in the sample set and μ is the sample set mean. In one embodiment, the analysis server can determine the standard deviation which can indicate the number of emails sent in a day is close to the average and therefore very consistent. If a single day has a number of emails that is higher than the average and the standard deviation is low, then it can indicate that there is abnormal email activity associated with that user (i.e., sender) account. Such activity could mean that the email account has been subject to unauthorized access and being used for spam or other undesirable purposes. In one embodiment, the analysis server creates a warning of potential unauthorized access to the sender's account when the current message behavior deviates from the baseline pattern by one standard deviation. Recognizing, however, that user's occasionally deviate from the baseline pattern, the analysis server is adapted to receive an approval of the current message behavior representing that the current message behavior is acceptable and that it should not cause the system to generate a warning based upon the current message behavior. Upon receiving such an approval, the analysis server can update the baseline behavior pattern and/or the behavior dataset to account for the current message behavior that has been approved so that similar behavior is less likely to trigger a warning in the future.

The analysis server can also determine a standard deviation for a group of users or entire message system and, when the number of emails being sent increases abruptly, it can indicate that the one or more email accounts or even the sender's message system has been subject to an unauthorized access and is being used for spam or another undesirable purpose.

The analysis server can also normalize the message historical information for analysis and can have the following functionality in its computer readable instructions allowing the analysis to serve and perform for a specific and specialized purpose:

$$Standard Score = \frac{X - μ}{σ}$$

$${Student}^{′} s t - statistic = \frac{\hat{β} - {β}_{0}}{s . e . ( \hat{β} )}$$

$$Studentized residual = \frac{\hat{{ε}_{l}}}{\hat{{σ}_{l}}} = \frac{{X}_{i} - \hat{{μ}_{l}}}{\hat{{σ}_{l}}}$$

$$Standard moment \frac{{μ}_{k}}{{σ}^{k}}$$

$$Coefficient of variation \frac{σ}{μ}$$

$$Variance to mean \frac{{σ}^{2}}{μ}$$

$$Min Max feature scaling {X}^{i} = \frac{X - {X}_{min}}{{X}_{mas} - {X}_{min}}$$

Referring to FIG. 2A, a total or some aggregate of emails that are provided to or calculated by the analysis server can be shown in graphical format. In this example, Monday seems to have the highest number of emails sent, about 50. In the event that the analysis server detects that some higher numbers of emails are being sent, such as one, two, or more standard deviations away from the mean, where such activity could mean that the email account has been subject to an unauthorized access and being used for spam or other undesirable purpose. Referring to FIG. 2B, the emails sent for Thursday shows a significant increased number that can indicate that unauthorized access has occurred.

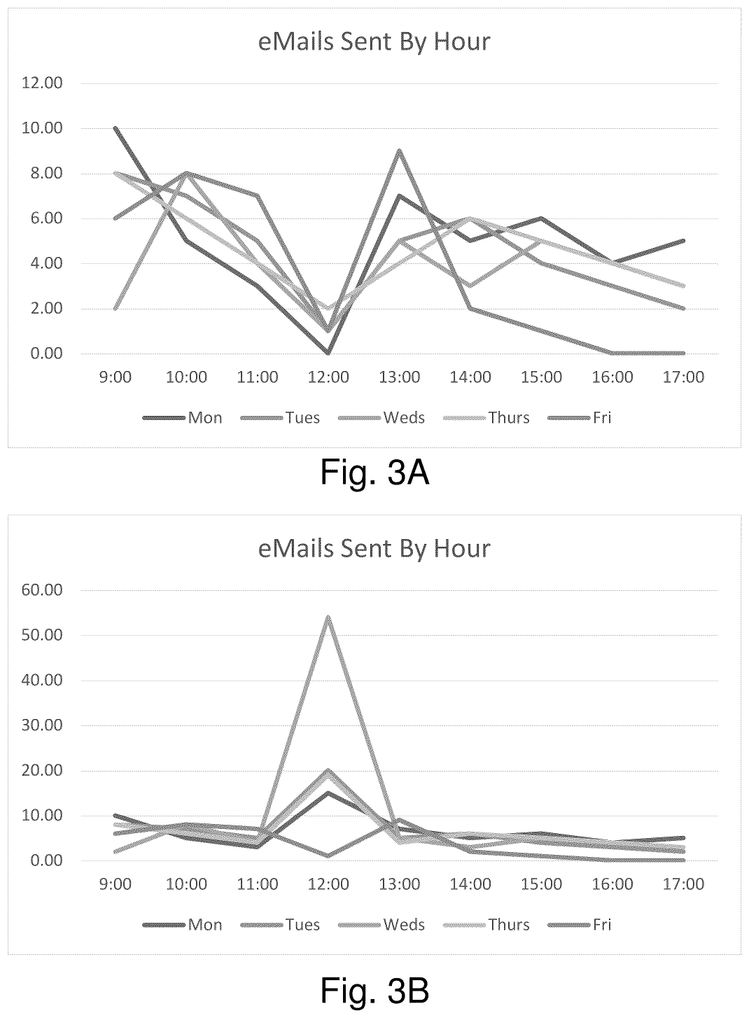

Referring to FIG. 3A, a total, or some aggregate of emails that are provided to or calculated by the analysis server, can be shown in graphical format that represent the number of emails sent per hour during a business day. In this example, there is a regular decrease around the noon hour which could indicate that there is a lunch hour or other out of office event at this time. Monday seems to have the highest number of emails sent, about 50. In the event that the analysis server detects that some higher numbers of emails are being sent that are outside the historical number per hour, such activity could mean that the email account has been subject to an unauthorized access and being used for spam or other undesirable purpose. Referring to FIG. 3B, the emails sent for the noon hour show a significant increased number that can indicate that unauthorized access has occurred. Further, if the user is out of the office and this volume of sent emails is discovered, it may show that the hacker has learned of the work habits of the account user and the hacker is taking advantage of the time that the user is not typically using the message system.

In one embodiment, the analysis server can determine if there is a potential unauthorized access situation by using tools such as a Z-score. The analysis server can use the Z-score to determine if messages being sent are within an acceptable range or if there is an anomaly. Generally, the Z-score provides an indication that email sending volumes, values, or other measures distance from the mean. The Z-score can be calculated by the following:

$$Z - score = \frac{x - μ}{σ}$$

Where x is the value to be measured, μ is the mean of the historical or set to be examined and σ is the standard deviation. In one embodiment, a Z-score greater than 1.0 can indicate that unauthorized access has occurred.

In one embodiment, the Z-score can be modified, especially for users with email sending patterns that are not normally distributed or when the user is a new user and there is not a large historical dataset. In these situations, the following modified Z-score can be used so that the analysis server is not overly sensitive to extreme values of emails being sent from the user's account.

$$Modified Z - score = \frac{0.6745 * ( x - μ )}{{\sum }_{1}^{n} \vert {x}_{i} - {x}^{∼} \vert / n}$$

The modified Z-score can assist with reducing the number of false positive hits for potential unauthorized access determinations. Other techniques that can be used by the analysis server and included in its computer readable instructions include the use of a interquartile range, box plot, and histogram. When analyzing new users or users with sporadic email sending patterns, the histogram can include logarithmic or square root values to seek a more normalized dataset set analytical result.

In one embodiment, the historical email sending data (e.g., volume, time, velocity, and the like) can be reviewed when the data is collected for a user or enterprise wide and on a daily or hourly frequency. According to the dataset, the analysis server can select an analysis model by using various models and determining the model that has the least errors. Errors can be determined by using the following equation embodied in computer readable instructions:

$$MAPE = \frac{100 \%}{n} {\sum }_{t - 1}^{n} \vert \frac{{A}_{i} - {F}_{i}}{{A}_{t}} \vert$$

where MAPE is the mean absolute percentage error, n number of fitted points, Aᵢ is the actual value and Fᵢ is the furcate value. The analysis server can overly the email sending data with seasonal correction data for a more accurate determination of the user's email sending patterns. For example, the analysis can adjust the dataset used for comparison with current activity for holiday including Memorial Day, Independent Day, Thanksgiving, Black Friday, Cyber Monday, December 24-26, January 1 and December 31, where reduced email sending use may be seen. Further, the analysis server can also correct for the potential increased use of email in the days prior to such holidays.

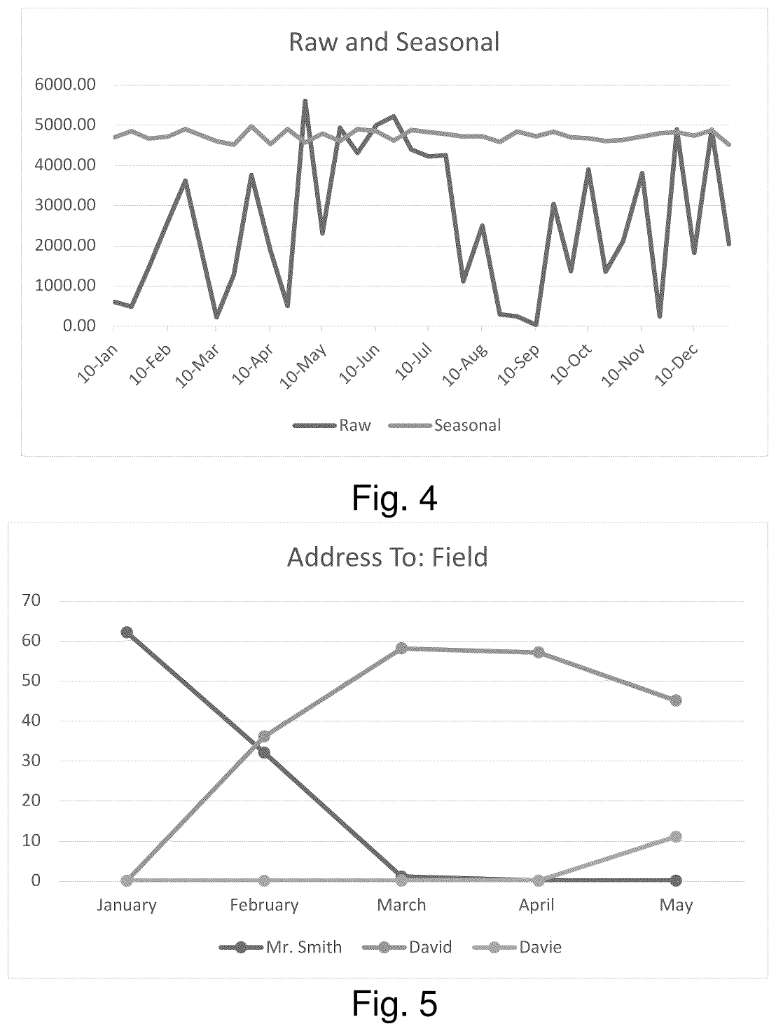

Referring to FIG. 4, the raw data shows the number of emails that are sent for an enterprise on a given day. The day, however, could be a weekend, holiday, or other day where emails are not expected to be as high as working days. Further, events such as closures, weather, emergencies, and the like can cause the data to be abnormally low or high according to the circumstance. For example, if an enterprise closes due to some event such as a pandemic, the email sending patterns may reflect the location of senders from remote location and not at the normal business location. The analysis can smooth this information so that the expected email activity per user or per enterprise can be adjusted for such events, such as seasonal events. Looking to the point after November 10, the dip can represent that the enterprise is closed for Thanksgiving. However, the analysis can determine that the email sending traffic for that day is typically much lower and adjust the expected volume or other value, as shown, but be seasonally adjusted data.

The analysis server can also develop a dynamic email sending pattern that can be associated with the user according to historical emails sent that is unique for each user. The pattern can be an analysis, including statistical analysis, of the emails sending pattern over some period of time. The sending pattern can be the behavior dataset indicative of a baseline pattern of sent messages which is used for comparison to a current message behavior associated with the sender's email account for purposes of determining whether there are anomalies which can indicate that there is unauthorized access to the sender's email account. The analysis server can also create or access a status data set associated with the sender, which may include information about the sender, including the sender's: schedule information, temporal information, location, login activity, logoff activity, mailbox activity, and any combination thereof. With respect to the sender's mailbox activity, the analysis server can also generate, analyze and/or receiving information regarding the sender's behavior with respect to email messages in the sender's account, including reading the message, deleting the message, preparing reply to the message, forwarding the message, quarantining the message or any combination thereof. The baseline pattern of sent messages associated with the user is calculated based, at least in part, upon the behavior dataset and the status dataset associated with the user. For example, the analysis server can determine that the user is or typically goes on holiday the first week of August and therefore reduce the potential for incorrectly determining reduced use of emails is during a holiday. The system can also determine that increased email use during a holiday can indicate unauthorized access. The system can also determine that the sender is not logged into his or her email account so that when an email is sent from the sender's account, the system will create a warning that unauthorized access to the sender's account is likely to have occurred. This warning may be transmitted to an administrator associated with the sender's message system. Whatever the triggering event may be that causes the system to generate a warning, the system may additionally or alternatively quarantine the message associated with the current message behavior that deviates from the baseline pattern and/or the behavior criteria associated with the sender.

These determinations can be made within a department, section, or enterprise wide. For example, the analysis server can determine that the business associated with the electronic message system is closed for the holiday between December 20 and January 2. Therefore, any increased email sending activity during this time can indicate unauthorized access.

In one embodiment, the analysis server can receive scheduling information that can represent the work hours of the user associated with an email account. In the event that there is email activity originating from the user's email account that is outside working hours as determined by the work schedule, the analysis server can indicate that the account may have been subject to an unauthorized access and being used for spam or other undesirable purpose.

In one embodiment, the analysis server can receive environmental information such as weather and can overlay this information with the email sending traffic. For example, if the electronic system is associated with a construction company and there is weather prohibiting a project from moving forward, email traffic for construction workers in the field may increase (e.g., not on the job site).

The analysis system can also be in communications with an access control system associated with the user. Generally, the access control system can control who is allowed at a location and when they are allowed at that location. If the access control system shows that the user is not at a location known to have the user's computer device, the analysis server can determine that there is email activity from the user's account when the user is not present to access the account.

The analysis server can also be in communications or receive information about the sender's location from a device such as a portable phone or smartphone. If the portable device information shows that the user is not at a location known to have the user's computer device, the analysis server can determine that there is email activity from the user's account when the user is not present to access the account. In one embodiment, the user account can include a sensitivity value that can represent the tolerance of deviations that trigger a warning or action for that account. For example, if the user is an executive in a large organization, the tolerance for deviation from standard email patterns can be reduced. For example, the CEO suddenly begins to send two or three times the number of emails to employees, especially to others with lower tolerances, it can indicate an unauthorized access.

In one embodiment, the email send statistics can be combined with email content that can be determined from past information. Referring to FIG. 5, and by way of example, the recipient's name is Mr. David Smith, and the sender frequency sends email to this recipient each month. This could be the relationship between a Chief Operating Office and a Chief Financial Officer. Further, this example shows that the sender addresses the recipient as Mr. Smith exclusively in January as you may expect with the sender or the recipient being newly introduced (e.g., new hire). As communication continues, the sender and recipient become more familiar and begin to address each other by the less formal given name rather than the family name. This shows that the use of the family name (“Smith”) decreases over time and the given name (“David”) increases from February to May. However, in May, the analysis system can determine from the sender's account that the sender has begun to use the “given name” Davie in May which can indicate an unauthorized access of the sender's account. Further, the analysis system can analyze the recipient account and determine that the sender has begun to use the “given name” David which can indicate an unauthorized access of the sender's account because of the address deviation. This analysis can be used in combination with other techniques and functions described herein including header information.

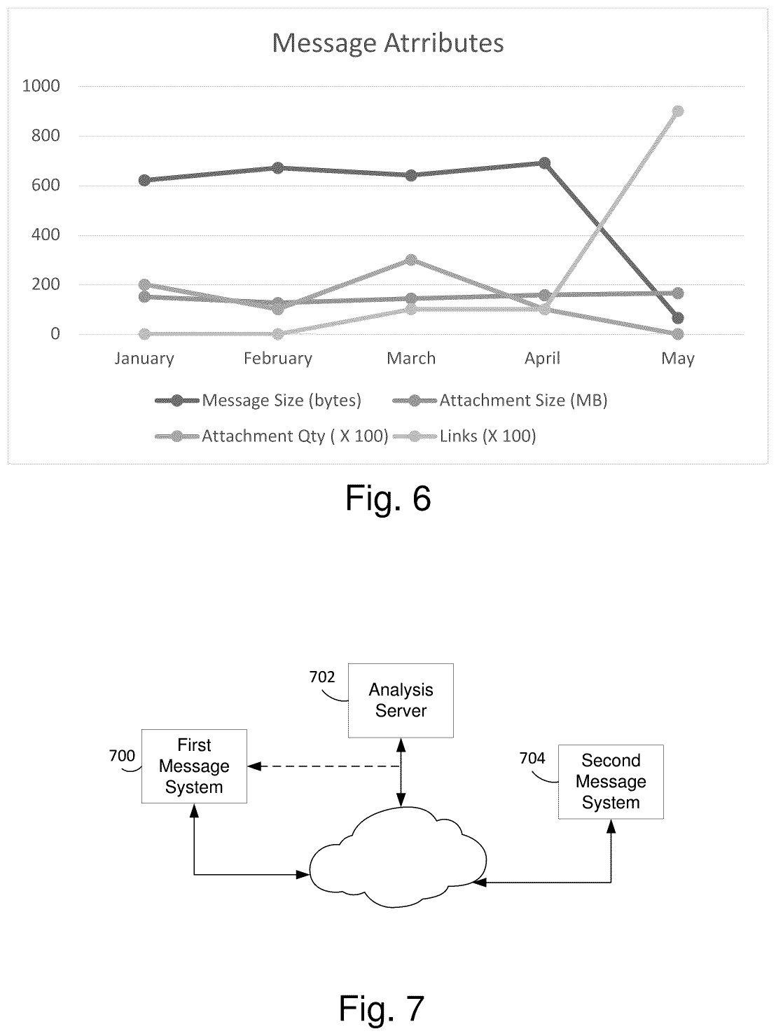

Referring to FIG. 6, the analysis server can gather and analyze the message attributes for one or more users, even to the enterprise level. The analysis server can determine that the average or otherwise normalized message size has a certain pattern. In the example of FIG. 6, the analysis server can determine that the average message size is about 600 bytes for the textual content of the message for one or more users. From this example, the month of May has shown a drastic decrease in message size which can indicate unauthorized access to the senders' account as the hacker may be using much less content than the proper sender. The analysis system can also determine the number of attachments that the sender historically sends (e.g., average, mean or other value) and can determine if a deviation from the historical pattern is detected. The increase in attachment can indicate unauthorized access in that undesirable file and information (e.g., malware) can be delivered by email attachment that can include an executable file (e.g., an .exe file extension) or text file (e.g., a .txt extension). Malicious email attachments can include hidden extensions seeking to have the recipient download the malicious file without knowledge of the potential the actual function of the file. Some malwares can be embedded in images, PDF and JPEG files. Such files can activate when they are opened. Therefore, an increase in attachment and the type of attachment can indicate unauthorized access to both sender accounts. The analysis system can detect potential indicating activity at the sender and recipient level.

The analysis server can also analyze the attachment size for an indication that the message potentially contains harmful content. When the size of the attachment changes from historic values, it can indicate unauthorized access. This can be true for both an increase and decrease in attachment seize as malware can be under 100 kB and exceeds 300 kB. Further, malware can exist in multiple file types such as .XLS, .PDF, .JS, .VBS, .DOCX, .DOC, .WSF, .XLSX, .EXE, and .HTML so that an increase in any of these file types in messages can indicate unauthorized access.

Referring to FIG. 7, the analysis system can be at the enterprise or wider level so that information from one message system can be used to improve the detection and reaction or another message system. The first message system can have a plurality of user accounts that can be used for both sending and receiving. The analysis server 702 can be in communications with the first message system. A second message system 704 can be in communication with the analysis server as well. In one embodiment, the analysis system can be in direct communications with the first message system and can be included in the first message system. The first message system can be the subject to an unauthorized access and the analysis server can determine that such unauthorized access has occurred as described herein. The sender's account can be identified and provided to the second message system so that the second message system can take action on a message stemming from the account that has been improperly accessed and potentially used. Therefore, the second message system can take advantage of the information and determination from the first message system when an unauthorized access is detected so that the negative effects of such a breach can be reduced or eliminated.

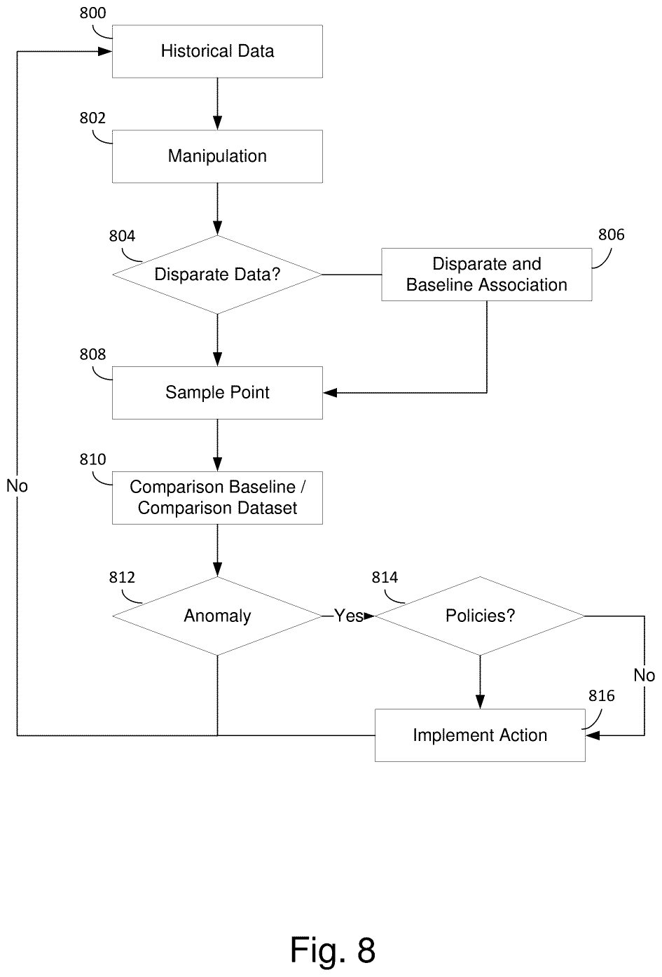

Referring to FIG. 8, the analysis server can gather historical information at the user, enterprise, and even global level at 800. The data can be manipulated at 802 for determining an average, mean, rolling values, normalization, statistical analysis and the like to generate a baseline email sending level and/or pattern. A baseline pattern can be developed using this information. A determination is made about the availability of disparate data is available at 804 such as weather, schedules, closings, holidays, interruptions, and the like. If so, the disparate data and the baseline pattern can be operatively associated at 806 as a comparison dataset for an analysis of a sample point (e.g., one day or one hour of sending traffic) for anomaly detection or determination. A sample point is determined at 808. The frequency of the sample point can be for each email received or can be for a certain period or time. The analysis server can increase or decrease the sample rate according to several factors including potential unauthorized access indication, disparate information, user activity, time, and any combination. Once the sample point is determined, it can be compared with the baseline at 810. A determination of an anomaly can be made at 812. If an anomaly is detected, the analysis can determine if policies are present at 814 and take action at 816 accordingly. The actions that the analysis server can take and that can be defined by polices for anomalies can include the following:

Generate a warning that can be transmitted to the electronic message system, administrator, recipient, third party (e.g., blacklist), reputation administrator, or other third party.

Lock the account of the sender.

Quarantine outbound electronic messages.

Delete the outbound messages.

Modify the header of the message indicating that the email is or may be from a compromised account.

Require a password reset for the sender's account.

Require multifactor authentication for the sender's account.

Initial a scan of the electronic message system of the user's account.

Require a chance in security questions.

And any combination of the above.

In one embodiment, the analysis server can edit the header information with triggers or other information that can indicate that the message may have come from a comprised account. In this example, the recipient's message system can determine the appropriate action. The triggers that are placed on the header information could result from any number of determinations by the analysis server and can represent level of anomalies from none, suspicious, probably unauthorized access, unauthorized access and the like. In this case, the analysis server does not actually have to take action according to the trigger and the trigger is simply associated with the electronic message. The trigger can be associated with the electronic message by editing the header information, adding information to the electronic message subject, adding information to the electronic message contact, adding an attachment and any combination thereof. Therefore, in one embodiment, the analysis server is amending the electronic message, including amending its header information, so that subsequent action could be taken, but does not necessarily have to be taken. This structure provides increased functionality and even security for existing electronic message systems that would not otherwise be possible.

The analysis server can also perform a security check on the sender electronic message system that could include a TLS encryption analysis, a MX record exposure, a DKIM presence, a SPF presence, a DMARC presence, a reputational information, a reverse DNS lookup consistency, a tracking item, information concerning other users (e.g., did other users delete, move, not open, open or take other cation on the same or similar electronic message) and any combination thereof

The analysis can also generate a security score according to the analysis described herein. The analysis can determine tracking information such as if the message sent from the potentially compromised account includes a tracking item or that a tracking item has been or should be added. In one embodiment, the tracking information is a tracking pixel or image that can be added to the message email that is sent. The analysis can determine that the tracking items is present and can take action or provide a trigger in the message for subsequent action (e.g., warning that a tracking pixel is present).

The message can be a computer-generated message or can be a sender generated message. The message can be a message composed by a human sender and provided to the sender's message system in digital form using computer readable code or human readable code such as human readable text.

The system described herein is directed to a series of acts that can detect unauthorized access. The computerized system is one that is at least directed to a process. The system can identify and potentially act upon electronic messages in an electronic message system according to the comparison with historical activity of the user account. The processes and procedures that are described herein can be actuated by a computer processor that executes computer readable instructions to provide the functionality herein.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. A computerized system for analysis of electronic communication systems comprising:
a computerized sender message system adapted to transmit an electronic message from a sender to a recipient;
a behavior dataset associated with the sender having behavior criteria associated with the sender taken from a group of send rate, transmission velocity, frequency, acceleration, deceleration, and any combination thereof segmented temporally;
a status dataset associated with the sender having status criteria taken from the group consisting of schedule information, temporal information, location, login activity, logoff activity, mailbox activity, and any combination thereof,
a computerized analysis system adapted to:
calculate a baseline pattern of sent message originating from the sender;
determine a current message behavior according to messages being sent from the sender;
generate a deviation when the current message behavior deviates from the baseline pattern, and
create a warning that the current message behavior deviates from the baseline pattern thereby indicating that a potential unauthorized access has occurred.

2. The system of claim 1 wherein the mailbox activity includes actions taken from the group consisting of the message being read, the message being deleted, a reply to the message transmitted, marking the message, forwarding the message, quarantining the message and any combination thereof.

3. The system of claim 1 wherein the baseline pattern is determined according to the behavior dataset and the status dataset.

4. The system of claim 1 wherein the warning is created when the current message behavior deviates from the baseline pattern by one standard deviation.

5. The system of claim 1 wherein the computerized analysis system is adapted to receive an approval of the current message behavior representing that the current message behavior is acceptable.

6. The system of claim 5 wherein the computerized analysis system is adapted to update the behavior dataset according to the current message behavior and an approval of the current message behavior.

7. The system of claim 1 wherein the deviation is generated when an origination location associated with the current message behavior deviates from an approved location associated with the sender.

8. The computerized analysis system of claim 1 wherein the deviation is generated when the current message behavior indicates that the sender is not logged on to the sender message system when the electronic message is created.

9. The computerized analysis system of claim 1 wherein the deviation is generated when a plurality of composed messages is transmitted according to a current message behavior that is inconsistent with the behavior dataset.

10. The computerized analysis system of claim 9 wherein the warning is created when the current message behavior is inconsistent by being 50% higher than one of the behavior criteria.

11. The computerized analysis system of claim 9 wherein the warning is created when the current message behavior is inconsistent with one of the behavior criteria during a certain time frame.

12. A computerized system for analysis of electronic communication systems comprising:
a computerized sender message system adapted to transmit an electronic message from a sender to a recipient;
a behavior dataset associated with the sender having behavior criteria associated with the sender taken from a group of send rate, transmission velocity, frequency, acceleration, deceleration, and any combination thereof segmented into time frames;
a computerized analysis system adapted to:
calculate a baseline pattern according to the behavior dataset;
determine a current message behavior according to messages being sent from the sender;
generate a deviation when the current message behavior deviates from the baseline pattern, and
create a warning that the current message behavior deviates from the baseline pattern.

13. The system of claim 12 wherein the computerized analysis system adapted to mark the electronic message as potentially malicious when the current message behavior deviates from the baseline pattern.

14. The system of claim 12 wherein the computerized analysis system is adapted to quarantine the electronic message when the current message behavior deviates from the baseline pattern.

15. The system of claim 14 wherein the computerized analysis system is adapted to generate a warning and transmit the warning to an administrator of the computerized sender message system when the current message behavior deviates from the baseline pattern.

16. A computerized system for analysis of electronic communication systems comprising:
a behavior dataset associated with a sender having behavior criteria associated with the sender taken from a group of send rate, transmission velocity, transmission frequency, transmission acceleration, transmission deceleration, and any combination thereof segmented into time frames;
a computerized analysis system in communications with a sender message system adapted to:
calculate a baseline pattern according to the behavior dataset;
determine a current message behavior according to a message sent from the sender message system for transmission to a recipient;
generate a deviation when the current message behavior deviates from the baseline pattern, and
create a warning that the current message behavior deviates from the baseline pattern.

17. The system of claim 16 where the baseline pattern is segmented into time frames.

18. The system of claim 17 wherein the computerized analysis system creates the warning that the current message behavior deviates from the baseline pattern for a specific time frame.

19. The system of claim 16 wherein the baseline pattern is generated using a normal distribution and the warning is created when the current message behavior deviates at least one standard deviation.

20. The system of claim 16 wherein the message is a composed message from the sender.
